(19) United States
(12) Patent Application Publication
(10) Pub. No.: US 2015/0349625 A1
(43) Pub. Date: Dec. 3, 2015

(54) POWER SUPPLY AND POWER CONVERSION CIRCUIT THEREOF

(71) Applicant: ELECTRONICS AND TELECOMMUNICATIONS RESEARCH INSTITUTE, Daejeon (KR)

(72) Inventors: Chang Hee HYOUNG, Daejeon (KR); Sung Weon KANG, Daejeon (KR); Kyung Hwan PARK, Daejeon (KR)

(73) Assignee: ELECTRONICS AND TELECOMMUNICATIONS RESEARCH INSTITUTE, Daejeon (KR)

(21) Appl. No.: 14/612,312

(22) Filed: Feb. 3, 2015

(30) Foreign Application Priority Data
May 30, 2014 (KR) 10-2014-0066482

(51) Int. Cl. H02M 1/42; H02M 7/217; H02M 1/44

(52) U.S. Cl. CPC H02M 1/4208; H02M 1/44; H02M 7/217; H02M 2001/0054

(57) ABSTRACT

A power supply including: a first rectifying unit rectifying an AC voltage into a DC voltage; a power factor correction (PFC) circuit increasing a level of the DC voltage to improve a power factor; a first converter converting the DC voltage with the corrected power factor to generate an output DC voltage; and a power conversion circuit converting electromagnetic interference (EMI) generated in the first converter into a reproducing voltage is provided.

### CROSS-REFERENCE TO RELATED APPLICATION

This application claims priority to and the benefit of Korean Patent Application No. 10-2014-0066482 filed in the Korean Intellectual Property Office on May 30, 2014, the entire contents of which are incorporated herein by reference.

### BACKGROUND OF THE INVENTION

(a) Field of the Invention

The present invention relates to a switching mode power supply converting an interference signal into power that is capable of being reproduced and a power conversion circuit.

(b) Description of the Related Art

A switching mode power supply (SMPS) as a power supply generating DC power from AC input power may stably generate an output voltage even if the voltage of the input power is changed. In general, the SMPS converts the AC input power into DC power through a rectifying and smoothing circuit and uses a semiconductor element as a switch. Since equipment is being down-sized and decreased in weight by increasing a switching frequency for down-sizing of an energy storage element, a high speed switching semiconductor element is required.

However, if the switching frequency becomes high, a power loss such as a switching loss or an inductor loss may be increased, heat may be seriously generated in the power supply, and a surge or noise may be generated in the switching.

Recently, in the SMPS, a semiconductor element such as a metal oxide semiconductor field effect transistor (MOSFET) has been used as the switch to be installed in a small space and to output with high efficiency and high capacity. As a feedback control circuit to stabilize the output voltage of the SMPS, a pulse width modulation (PWM) type and a pulse frequency modulation (PFM) type are used.

Among them, the PWM type generates a pulse signal of which a duty is changed by using voltage feedback in the output voltage, a reference voltage, and a pulse signal waveform of an oscillator and controls voltage application to a transformer according to the generated pulse signal, thereby generating a constant output voltage. In the PWM type, the pulse width is changed according to an output error, and when a load is large, the pulse width is largely changed, and the pulse width is changed a small amount when the load is small. As a capacitance size of the smoothing condenser is increased, an instant charging amount is increased such that many peak currents may discontinuously inflow to the DC power applied a primary coil. The discontinuous peak current flowing into the DC power distorts the voltage, generates a harmonic wave component to the current, and decreases a power factor.

Accordingly, a power factor correction (PFC) circuit as a power-saving circuit configured of the semiconductor element to improve the power-efficiency of the SMPS by correcting the power factor may be used. In the PFC, there are a passive PFC that may be simply realized, however the power factor is low and the control of the harmonic wave component is different, and an active PFC of which the power factor may be largely improved by using a boost-up type, but an input power circuit is complicated and cost thereof is high.

The active PFC as a type for maximizing efficiency after increasing the AC input power to DC 400 V has power efficiency more than 95%, thereby having a high power-saving effect. Also, the PFC is operated at AC input power in an 80-265 V range without a AC power selection switch, the weight thereof is low, and audio noise of a home band is not generated in the PFC circuit.

However, the active PFC generates noise of a high frequency such that fatigue of a user may be accumulated during long time use. Therefore, a limit of the noise signal by electromagnetic wave interference (EMI) is defined by an international standard. In the international standard related to the EMI, a voltage value measured by using a quasi-peak detector is required to satisfy a predetermined degree in a predetermined bandwidth with reference to each frequency. FIG. 1 shows an international standard related to EMI.

The SMPS executes the switching with a higher frequency than the frequency of the input AC power, and a conductive interference signal is generated in a transmitting pathway of the switching signal. This interference signal is widely distributed in several frequency bandwidths.

FIG. 2 is a graph for measuring a conductive interference signal generated at four different time scale near a fluorescent ballast using the SMPS in a time domain. Referring to FIG. 2, it may be confirmed that conductive interference signals of various frequency are generated near the fluorescent ballast using the SMPS.

Also, in the switching converter, a power ripple of a low frequency flowing in from the AC input power, a ripple caused by a high frequency of several tens to hundreds of megahertz, and an impulse noise component may appear in the DC output voltage. If the ripple and the noise component are not completely removed in the smoothing circuit and flow in at more than the limit of the system, the system may malfunction.

Accordingly, to control the output ripple and the noise component and satisfy the EMI standard, many diodes and a complicated circuit using an RC snubber circuit are used. Whether the conductive interference signal is generated at any position of the circuit has been known through research to reduce the electrometric wave interference of the SMPS, conventionally, a bead or the snubber for attenuation of the interference signal is inserted into the circuit at the generation position of the signal. Also, an inner circuit controlling a modulation range of the switching frequency by separately adding an external device or sensing the voltage or the current signal is installed.

However, in the conventional art, the method of attenuating or removing the noise and the EMI signal generated in the switching mode power supply has been developed such that production cost according to a design change is increased and a volume of the equipment is increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

Accordingly, an exemplary embodiment of the present invention provides a power supply with improved efficiency of a power supplier by obtaining power from a leakage EMI signal when operating a switching mode power supply in a switching circuit operated with a high frequency, supplying a new voltage of a different level from an output voltage, and reusing the obtained power in the power supply and a power conversion circuit of the power supply.

A power supply according to the present invention is provided. The power supply includes: a first rectifying unit rectifying an AC voltage into a DC voltage; a power factor correction (PFC) circuit increasing a level of the DC voltage to improve a power factor; a first converter converting the DC voltage with the corrected power factor to generate an output DC voltage; and a power conversion circuit converting electromagnetic interference (EMI) generated in the first converter into a reproducing voltage.

The power conversion circuit may convert the EMI signal generated between the PFC circuit and a power switch of the first converter among the EMI signal into the reproducing voltage.

The power conversion circuit may supply the reproducing voltage to the PFC circuit.

The power conversion circuit may supply the reproducing voltage to an output smoothing unit of the first converter.

The power conversion circuit may supply the reproducing voltage to a load connected to the power supply.

The power conversion circuit may convert the EMI signal generated between the power switch of the first converter and a transformer circuit of the first converter among the EMI signal into the reproducing voltage.

The power conversion circuit may supply the reproducing voltage to the PFC circuit.

The power conversion circuit may supply the reproducing voltage to an output smoothing unit of the first converter.

The power conversion circuit may supply the reproducing voltage to a load connected to the power supply.

The power conversion circuit may include a first power conversion circuit converting the first EMI signal generated between the PFC circuit and the power switch of the first converter among the EMI signal into a first reproducing voltage, and a second power conversion circuit converting a second EMI signal generated between the power switch of the first converter and a transformer circuit of the first converter among the EMI signal into a second reproducing voltage.

The power conversion circuit may include a first power conversion circuit converting the first EMI signal generated between the PFC circuit and the power switch of the first converter among the EMI signal into a first reproducing voltage, and a second power conversion circuit adding and converting a second EMI signal generated between the power switch of the first converter and a transformer circuit of the first converter among the EMI signal and the first reproducing voltage into a second reproducing voltage.

The power supply may further include a filter unit absorbing a surge current of the AC voltage and removing noise to transmit the AC voltage with the noise removed to the first rectifying unit.

The power conversion circuit may include a second rectifying unit generating a DC voltage based on the EMI signal generated in the power supply, and a voltage multiplication unit boosting up the DC voltage.

The power conversion circuit may include a ferrite bead for matching impedance of the power supply and impedance of the power conversion circuit.

The power supply may further include a matching circuit transmitting the DC voltage with the power factor corrected to the first converter and the EMI signal to the power conversion circuit.

The matching circuit may include a capacitor and an inductor, and transmits the DC voltage with the power factor corrected to the first converter through the inductor and the EMI signal to the power conversion circuit through the capacitor.

According to another exemplary embodiment of the present invention, a power conversion circuit of a power supply is provided. The power conversion circuit includes a rectifying unit generating a DC voltage based on an electro-magnetic interference (EMI) signal generated in the power supply, and a voltage multiplication unit boosting up the DC voltage to generate a reproducing voltage.

The rectifying unit may generate the DC voltage based on the EMI signal generated between the PFC circuit of the power supply and the power switch of the power supply among the EMI signal.

The rectifying unit may generate the DC voltage based on the EMI signal generated between the power switch of the power supply and a transformer circuit of the power supply among the EMI signal.

### BRIEF DESCRIPTION OF THE DRAWINGS

FIG. 1 shows an international standard related to an EMI.

FIG. 2 is a graph for measuring a conductive interference signal generating at four different time scale near a fluorescent ballast using the SMPS in a time domain.

FIG. 3A is a view of a power supply according to an exemplary embodiment of the present invention.

FIG. 3B is a view of a matching circuit according to an exemplary embodiment of the present invention.

FIG. 4 is a view of a power supply according to another exemplary embodiment of the present invention.

FIG. 5 and FIG. 6 are views of a power supply according to another exemplary embodiment of the present invention.

FIG. 7 and FIG. 8 are circuit diagrams of a power conversion circuit according to an exemplary embodiment of the present invention.

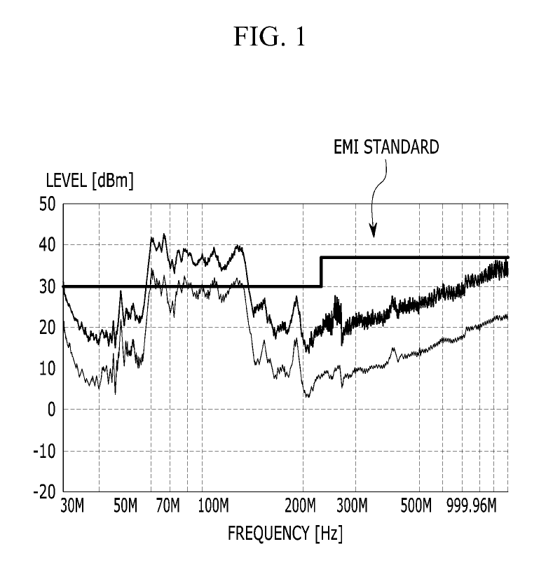

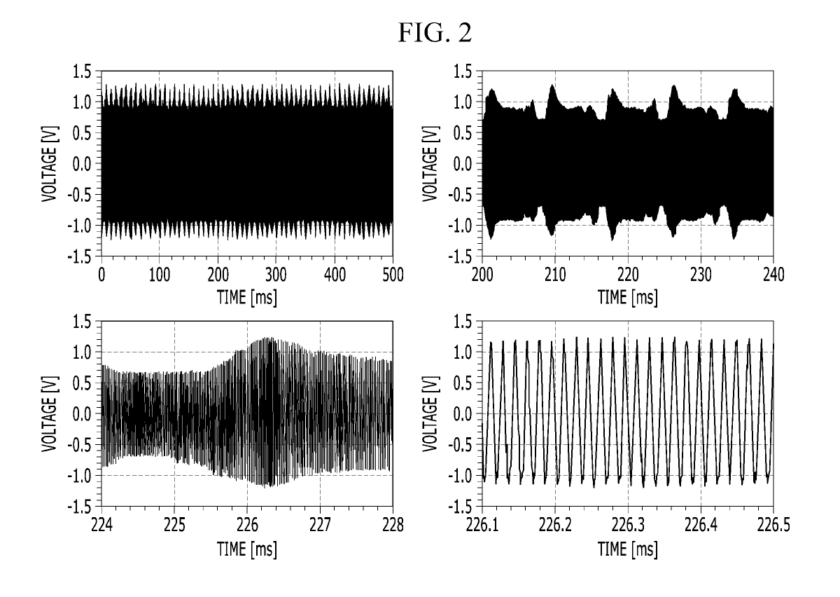

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” and variations such as “comprises” will be understood to imply the inclusion of stated elements but not the exclusion of any other elements. Also, the terms of a unit, a device, and a module in the present specification represent a unit for processing a predetermined function or operation, which can be realized by hardware, software, or a combination of hardware and software.

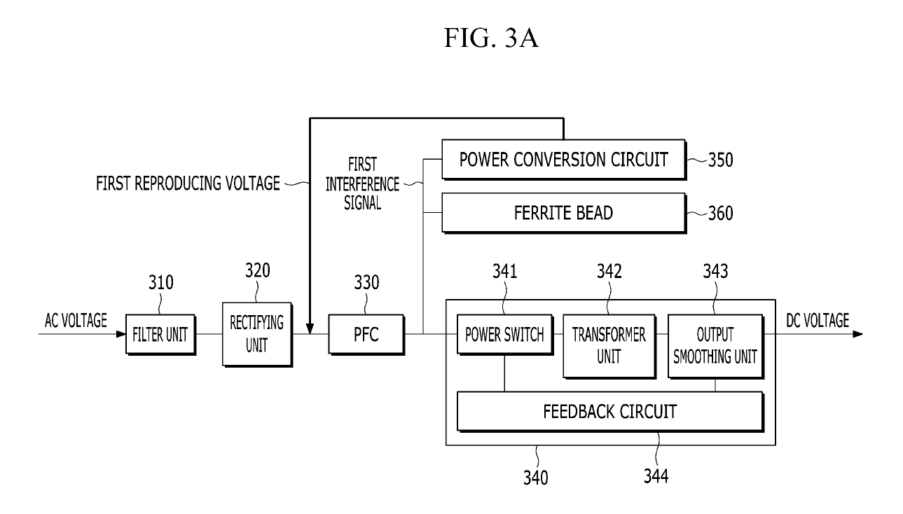

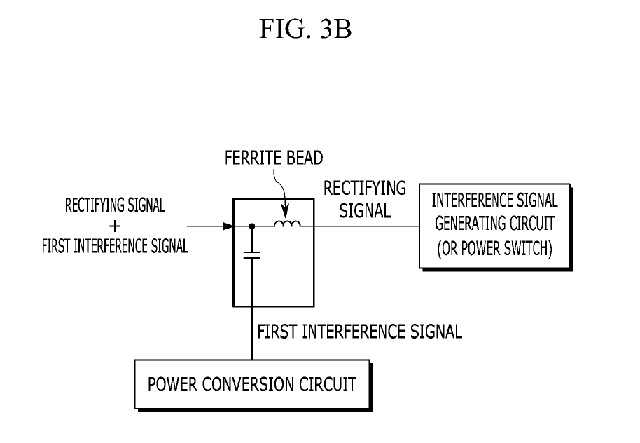

FIG. 3A is a view of a power supply according to an exemplary embodiment of the present invention.

Referring to FIG. 3A, the power supply according to an exemplary embodiment of the present invention includes a filter unit 310, a rectifying unit 320, a PFC 330, a first converter 340, and a power conversion circuit 350.

The filter unit 310 removes the noise of the input AC voltage of a predetermined range, and absorbs a surge current to transmit the AC voltage with the noise removed to the rectifying unit 320.

The rectifying unit 320 smoothes and rectifies the AC voltage with the noise removed in the filter 310 into a DC voltage. The PFC 330 is a power factor compensation circuit that improves a power factor after increasing the amplitude of the smoothed and rectified DC voltage to a predetermined level. Since an instantaneous charging amount is increased as the capacitance of the rectifying unit 320 is increased, a large peak current may discontinuously flow into the DC power applied to a primary coil of a voltage transformation unit. At this time, the peak current distorts the voltage such that the harmonic wave component of the current and the power factor may be decreased. Accordingly, to correct the power factor and to improve power efficiency of the power supply, the PFC 330 as the power saving circuit configured of the semiconductor element may be used. The passive PFC and the active PFC may be used in the power supply according to an exemplary embodiment of the present invention. The passive PFC may be simply realized, however the power factor improvement effect is small and it is used to control the harmonic wave component. The active PFC has the large power factor improvement effect by using a boost-up method, however a circuit of an input power unit is complicated and expensive.

The first converter 340 converts the DC voltage to be output. The first converter 340 includes a power switch 341, a voltage transformation unit 342, an output smoothing unit 343, and feedback circuit 344.

The power switch 341 switches the power by a pulse signal, and may control a current supply time to the voltage transformation unit 342.

The voltage transformation unit 342 may transform the output voltage into a predetermined size by the switching operation.

The output smoothing unit 343 smoothes the transformed voltage to generate the stable output voltage.

The feedback circuit 344 feeds back the output voltage to the power switch 341. At this time, the feedback circuit 344 may generate the pulse signal of which the duty is changed by using the output voltage, the reference voltage, and the pulse signal of the oscillator. The generated pulse signal controls the power switch 341 to generate the output voltage of the predetermined level. That is, the pulse width corresponding to the output error is generated such that the pulse width is large if the load is large and the pulse width is small if the load is small, thereby constantly maintaining the size of the output voltage.

The power conversion circuit 350 may generate a reproducing voltage by using an EMI signal generated in the power supply. Hereafter, the power conversion circuit 350 will be described in detail.

The power supply according to an exemplary embodiment of the present invention receives the AC voltage to output the DC voltage. At this time, the power conversion circuit 350 is inserted at a position where the EMI signal is generated to generate the reproducing voltage by using the EMI signal. The reproducing voltage generated in the power conversion circuit 350 of the power supply according to an exemplary embodiment of the present invention is again input to the power supply, thereby decreasing power consumption of the power supply device.

On the other hand, at the position where the EMI signal is generated, the efficiency of the power conversion circuit 350 may be changed according to an impedance matching characteristic between the impedance of the circuit generating the EMI signal and the impedance of the power conversion circuit 350. The power conversion circuit 350 according to an exemplary embodiment of the present invention inserts the impedance matching circuit between the position where the interference signal is generated and the power conversion circuit 350, and connects a load impedance to a voltage boosting unit of the power conversion circuit 350, thereby maximally obtaining the power from the EMI signal.

The power conversion circuit 350 according to an exemplary embodiment of the present invention may use a ferrite bead 360 in a way to suppress or attenuate the EMI signal as one part of the input circuit. That is, the ferrite bead 360 may attenuate the EMI signal, however the ferrite bead 360 may match the impedance between the power conversion circuit 350 and the circuit generating the EMI signal in an exemplary embodiment of the present invention. The general ferrite bead is coupled in series to the circuit, thereby passing a low frequency signal (the output signal of the rectifying unit according to an exemplary embodiment of the present invention) and blocking the high frequency signal. That is, the ferrite bead performs a filter function of blocking the high frequency signal from being input to the converter, because the ferrite bead has the high impedance to the high frequency signal to be operated like a large resistor.

The power conversion circuit 350 according to an exemplary embodiment of the present invention needs to have the high impedance in the low frequency that is the operation frequency bandwidth of the system and the low impedance in the high frequency to easily receive the first interference signal. In an exemplary embodiment of the present invention, by using this characteristic of the power conversion circuit 350, the matching circuit having the high impedance in the low frequency and the low impedance in the high frequency may be added to the input end of the power conversion circuit 350. In this case, the matching circuit may include the ferrite bead.

FIG. 3B is a view of a matching circuit according to an exemplary embodiment of the present invention.

FIG. 3B shows the matching circuit of a simplest shape expressed by a capacitor and an inductor (the ferrite bead). If the rectifying signal and the first interference signal are input together to the matching circuit, the first interference signal of the high frequency may only be input to the power conversion circuit by the capacitor of the matching circuit, and the rectifying signal of the low frequency may only be input to the first converter by the inductor (the ferrite bead) of the matching circuit.

Referring to FIG. 3A, the power conversion circuit 350 according to an exemplary embodiment of the present invention may convert the EMI signal (hereafter referred to as “a first interference signal”) generated between the PFC 330 and the power switch 341 into the first reproducing voltage.

On the other hand, the power supply may supply the large power according to the load, and in this case, a large amount of heat is generated in the circuit. In this case, the DC voltage may be obtained through a thermoelectric element converting the heat generated in the circuit into electricity, and the boost up converter of the power conversion circuit 350 may be formed by using the first interference signal as a switching control signal. By using this device, the waste heat and the leakage electromagnetic signal may both be activated such that the efficiency of the power supply and the electromagnetic interference characteristic may be improved and the waste heat may be recycled.

The power conversion circuit 350 shown in FIG. 3A converts the first interference signal generated in the PFC 330 into the first reproducing voltage and supplies the converted first reproducing voltage to the rectifying unit 320 and the PFC 330, however this is only an exemplary embodiment of the present invention. That is, the power conversion circuit 350 of the present invention may supply the first reproducing voltage to the arbitrary circuit required with the power and receives the interference signal at all positions where the interference signal source exists to be converted into the reproducing voltage.

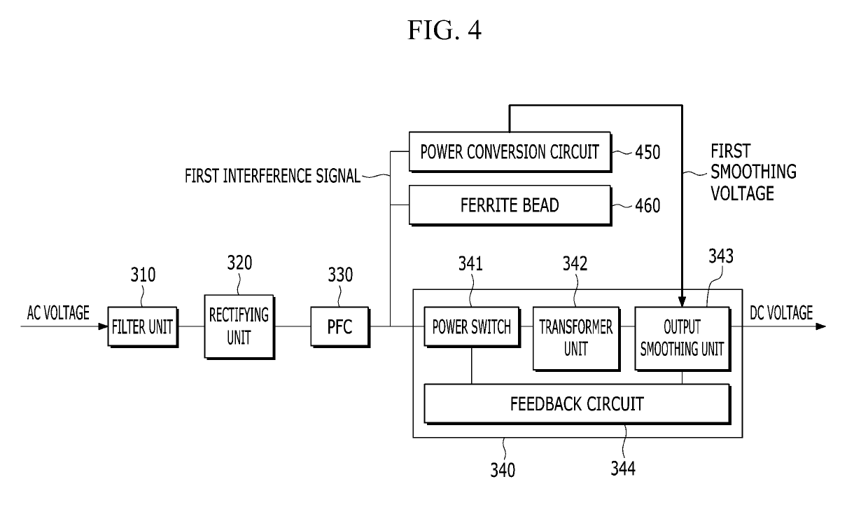

FIG. 4 is a view of a power supply according to another exemplary embodiment of the present invention.

Referring to FIG. 4, the power conversion circuit 450 of the power supply according to the current exemplary embodiment of the present invention converts the first interference signal to supply the output reproducing voltage to the output smoothing unit 343. The reproducing voltage supplied to the output smoothing unit 343 additionally outputs the reproducing power obtained from the power conversion circuit 450, thereby helping the improvement of the efficiency of the power supply device.

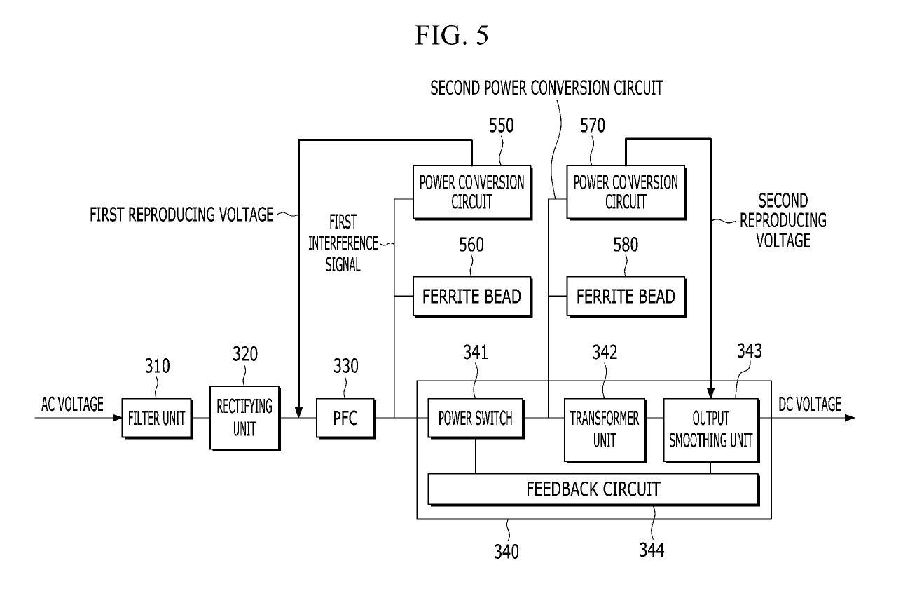

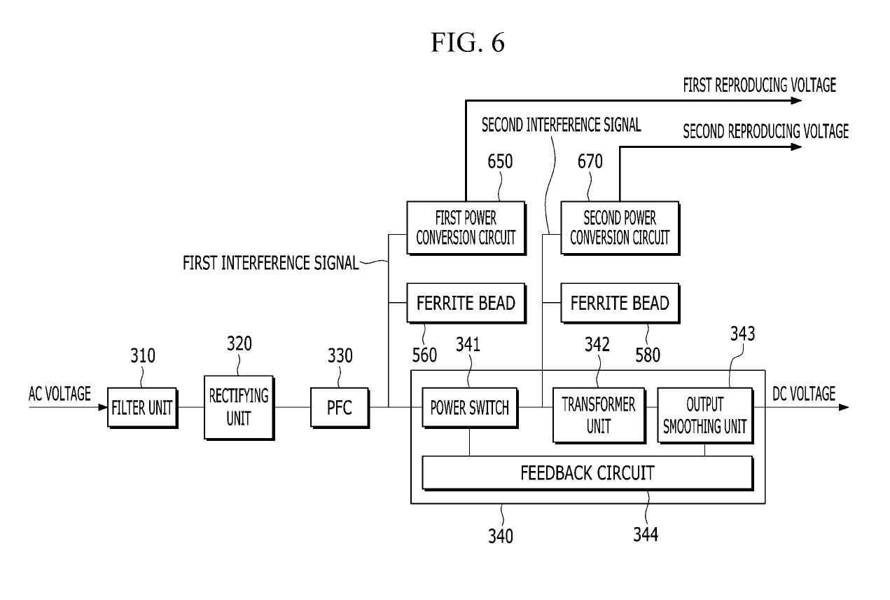

FIG. 5 and FIG. 6 are views of a power supply according to another exemplary embodiment of the present invention.

The power supply shown in FIG. 5 and FIG. 6 includes a first power conversion circuit 550 and a second power conversion circuit 570.

The first power conversion circuit 550 may output the first reproducing voltage by using the EMI signal generated between the PFC 330 and the power switch 341 like the power supply shown in FIG. 3 and FIG. 4.

The second power conversion circuit 570 may output the second reproducing voltage by using the EMI signal (hereafter, referred to as “a second interference signal”) generated between the power switch 341 and the voltage transformation unit 342.

The first reproducing voltage and the second reproducing voltage may be activated.

The first reproducing voltage may be input to the PFC 330 and the second reproducing voltage may be input to the output smoothing unit 343 (FIG. 5).

The first reproducing voltage and the second reproducing voltage may both be directly used in the load or may both be input to the output smoothing unit 343 (FIG. 6).

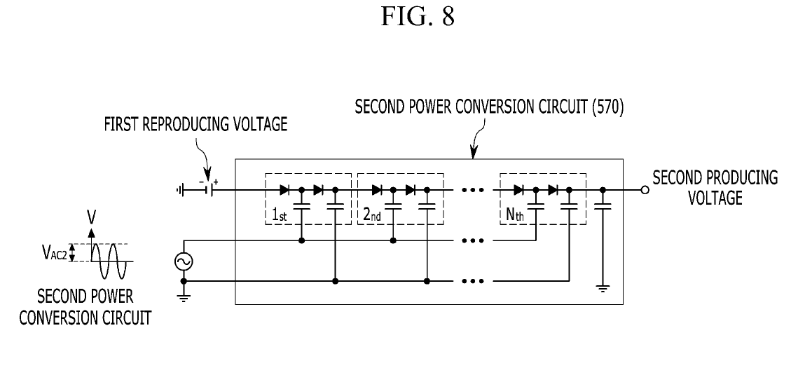

The first reproducing voltage may be input to the second power conversion circuit 570 and the second power conversion circuit 570 may output the second reproducing voltage that the basic voltage of the first reproducing voltage is boosted up by the voltage obtained from the second interference signal (in this case, the switching signal may be used). FIG. 8 shows the power conversion circuit outputting the second reproducing voltage by using the first reproducing voltage as the basic voltage.

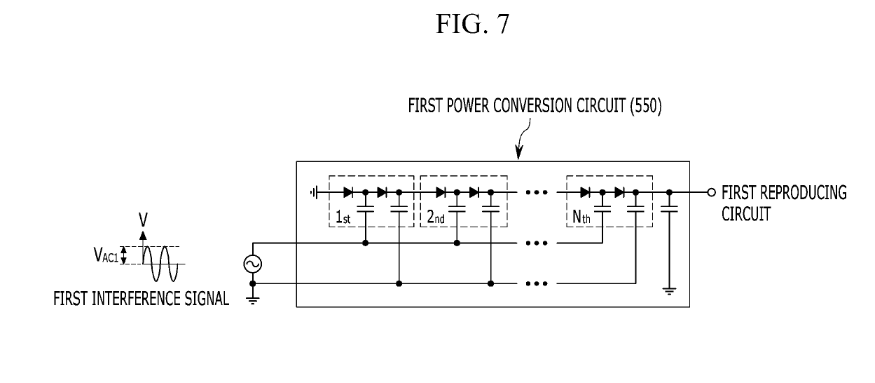

FIG. 7 is a circuit diagram of a first power conversion circuit according to an exemplary embodiment of the present invention, and FIG. 8 is a circuit diagram of a second power conversion circuit according to an exemplary embodiment of the present invention.

Referring to FIG. 7 and FIG. 8, the first power conversion circuit and the second power conversion circuit according to an exemplary embodiment of the present invention include a second rectifying unit and a voltage multiplication unit. The second rectifying unit may include a first voltage multiplication circuit of the voltage multiplication circuits 551 and 571 shown in FIG. 7 and FIG. 8. The second rectifying unit may rectify the EMI signal to be generated into the DC voltage.

The voltage multiplication unit may include a second following voltage multiplication circuit of the voltage multiplication circuits 551 and 571 shown in FIG. 7 and FIG. 8. The voltage multiplication unit may boost up the DC voltage generated by using the EMI signal as the switching signal. In this case, a number of voltage multiplication circuits for the boost up may be determined according to the size of the EMI signal and the size of the output voltage. The EMI signal is generally lower than the size of the voltage required for the circuit driving. A degree that the voltage multiplication unit boosts up the voltage may be determined according to the size of the voltage required for the load.

Referring to FIG. 8, the power conversion circuit according to an exemplary embodiment of the present invention may be input with the DC voltage leaked at the arbitrary position of the voltage supply device or the voltage supply device as the basic voltage. Next, the power conversion circuit may boost up and output the basic voltage by the reproducing voltage. According to an exemplary embodiment of the present invention shown in FIG. 8, the basic voltage input to the power conversion circuit may be the first reproducing voltage generated in the first power conversion circuit. Also, according to another exemplary embodiment of the present invention, the basic voltage input to the power conversion circuit may be the output voltage of the thermoelectric element.

The power conversion circuit (350, 450, 550, 650, and 670) of an exemplary embodiment of the present invention may convert the AC input voltage to the DC output voltage, and the half bridge rectifier and full bridge rectifier may be used for the power conversion circuit like the voltage multiplier.

As described above, according to an exemplary embodiment of the present invention, by reproducing the power through the EMI signal inevitably generated in the switching mode power supply, the negative influence of the EMI signal is blocked and the efficiency of the power supply may be increased.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A power supply comprising:
a first rectifying unit rectifying an AC voltage into a DC voltage;
a power factor correction (PFC) circuit increasing a level of the DC voltage to improve a power factor;
a first converter converting the DC voltage with the corrected power factor to generate an output DC voltage; and
a power conversion circuit converting electromagnetic interference (EMI) generated in the first converter into a reproducing voltage.

2. The power supply of claim 1, wherein
the power conversion circuit converts the EMI signal generated between the PFC circuit and a power switch of the first converter among the EMI signal into the reproducing voltage.

3. The power supply of claim 2, wherein
the power conversion circuit supplies the reproducing voltage to the PFC circuit.

4. The power supply of claim 2, wherein
the power conversion circuit supplies the reproducing voltage to an output smoothing unit of the first converter.

5. The power supply of claim 2, wherein
the power conversion circuit supplies the reproducing voltage to a load connected to the power supply.

6. The power supply of claim 1, wherein
the power conversion circuit converts the EMI signal generated between the power switch of the first converter and a transformer circuit of the first converter among the EMI signal into the reproducing voltage.

7. The power supply of claim 6, wherein
the power conversion circuit supplies the reproducing voltage to the PFC circuit.

8. The power supply of claim 6, wherein
the power conversion circuit supplies the reproducing voltage to an output smoothing unit of the first converter.

9. The power supply of claim 6, wherein
the power conversion circuit supplies the reproducing voltage to a load connected to the power supply.

10. The power supply of claim 1, wherein
the power conversion circuit includes: a first power conversion circuit converting the first EMI signal generated between the PFC circuit and the power switch of the first converter among the EMI signal into a first reproducing voltage; and
a second power conversion circuit converting a second EMI signal generated between the power switch of the first converter and a transformer circuit of the first converter among the EMI signal into a second reproducing voltage.

11. The power supply of claim 1, wherein
the power conversion circuit includes a first power conversion circuit converting the first EMI signal generated between the PFC circuit and the power switch of the first converter among the EMI signal into a first reproducing voltage, and
a second power conversion circuit adding and converting a second EMI signal generated between the power switch of the first converter and a transformer circuit of the first converter among the EMI signal and the first reproducing voltage into a second reproducing voltage.

12. The power supply of claim 1, further comprising
a filter unit absorbing a surge current of the AC voltage and removing noise to transmit the AC voltage with the noise removed to the first rectifying unit.

13. The power supply of claim 1, wherein
the power conversion circuit includes:
a second rectifying unit generating a DC voltage based on the EMI signal generated in the power supply; and
a voltage multiplication unit boosting up the DC voltage.

14. The power supply of claim 13, wherein
the power conversion circuit includes a ferrite bead for matching impedance of the power supply and impedance of the power conversion circuit.

15. The power supply of claim 1, further comprising
a matching circuit transmitting the DC voltage with the power factor corrected to the first converter and the EMI signal to the power conversion circuit.

16. The power supply of claim 1, wherein
the matching circuit includes a capacitor and an inductor, and transmits the DC voltage with the power factor corrected to the first converter through the inductor and the EMI signal to the power conversion circuit through the capacitor.

17. A power conversion circuit of a power supply, comprising:
a rectifying unit generating a DC voltage based on an electro-magnetic interference (EMI) signal generated in the power supply; and
a voltage multiplication unit boosting up the DC voltage to generate a reproducing voltage.

18. The power conversion circuit of claim 17, wherein
the rectifying unit generates the DC voltage based on the EMI signal generated between the PFC circuit of the power supply and the power switch of the power supply among the EMI signal.

19. The power conversion circuit of claim 17, wherein
the rectifying unit generates the DC voltage based on the EMI signal generated between the power switch of the power supply and a transformer circuit of the power supply among the EMI signal.
